(19) United States
(12) Patent Application Publication
(10) Pub. No.: US 2015/0322280 A1
(43) Pub. Date: Nov. 12, 2015

(54) MULTI-LAYERED SCRATCH RESISTANCE FILM

(71) Applicant: UNIPIXEL DISPLAYS, INC, The Woodlands, TX (US)

(72) Inventors: Danliang JIN, The Woodlands, TX (US); Robert J. PETCAVICH, The Woodlands, TX (US)

(73) Assignee: UNIPIXEL DISPLAYS, INC, The Woodlands, TX (US)

(21) Appl. No.: 14/275,509

(22) Filed: May 12, 2014

(51) Int. Cl. C09D 133/08; B05D 3/06; B05D 7/00

(52) U.S. Cl. CPC C09D 133/08; B05D 7/546; B05D 3/068

(57) ABSTRACT

A scratch resistant film formed by altering a surface energy of at least a portion of a substrate and disposing a first layer of coating on the substrate. The first layer of coating comprises a plurality of functionalized monomers and a solvent. The substrate then may enter a transition zone to wet the first layer of coating, wherein wetting the first layer of coating comprises disposing the substrate in a transition zone subsequent to disposing the first layer of coating. The first layer of coating is cured, and a second layer of coating is disposed on the first layer of coating, wherein the second layer of coating has a lower surface energy than the first layer of coating. The substrate may then enter a transition zone and be subsequently cured. A scratch-resistant film is formed; this film may be transparent, translucent, opaque, or combinations thereof.

### CROSS-REFERENCE TO RELATED APPLICATION

None.

### BACKGROUND

Touch screen technology has become an important component of many modern electronics, such as tablet computers and cellular phones. Typically, touch screen technology incorporates the use of resistive or capacitive sensor layers which make up part of the display. Screens for devices which utilize such technology are often prone to damage due to the increased level of direct contact by the user with the screen. Such damage typically includes both scratching and breakage of the screen itself depending on the materials used and the use thereof. As a result, resistive and capacitive touch sensors usually include translucent electrically insulating covers placed on top of the display structure in order to protect and isolate the touch sensor panel from environmental conditions, abrasion, oxygen, and harmful chemical agents.

Typically, glass or polyester films are employed as protective covers in touch screen panels. Polyester films, while flexible, can only provide a minimal level of hardness. Specifically, such films provide a surface pencil hardness ranging about 1H-2H. Therefore, polyester films are susceptible to scratches. Additionally, glass covers, which are able to produce pencil hardness readings above 7H, do provide very good scratch protection. However, such glass covers do not provide a high level of flexibility and are therefore susceptible to breaking upon impact with a hard surface.

### SUMMARY

In an embodiment, a scratch resistant film, comprising: a substrate; and a coating disposed on the substrate, wherein the coating comprises a cross-linked polymer structure formed from a plurality of functionalized monomers, wherein the coating comprises a plurality of layers, wherein the scratch resistant film has a pencil hardness of at least 6H.

In an embodiment, a method of manufacturing a scratch resistant film, comprising: altering a surface energy of at least a portion of a substrate; disposing a first layer of coating on the substrate, wherein the first layer of coating comprises a plurality of functionalized monomers and a solvent; curing the first layer of coating; disposing a second layer of coating on the first layer of coating, wherein the second layer of coating has a lower surface energy than a surface energy of the first layer of coating; curing the second layer of coating; and forming, in response to curing the second layer of coating, a scratch-resistant film.

In an alternate embodiment, a scratch resistant film, comprising: a substrate; a scratch resistant coating disposed on the substrate; wherein the scratch resistant coating comprises a cross-linked polymer structure comprising a plurality of layers and formed from a plurality of functionalized monomers; wherein a pencil hardness of the scratch-resistant coating is at least 6H.

### BRIEF DESCRIPTION OF THE DRAWINGS

For a detailed description of exemplary embodiments of the invention, reference will now be made to the accompanying drawings in which:

FIG. 1 shows both a linear polymer structure (A) as well as a cross-linked polymer structure (B) in accordance with an embodiment of the invention.

FIG. 2 shows a schematic view of an embodiment of the method for making a scratch resistant film.

FIG. 3 shows a schematic view of an alternative method for making a scratch resistant film according to embodiments of the present disclosure.

FIG. 4 shows a schematic view of still another alternative method for making a scratch resistant film according to embodiments of the present disclosure.

FIG. 5 depicts a schematic view of a cross-section of the scratch resistant film in accordance with an embodiment of the invention.

FIG. 6 shows the apparatus for conducting a pencil hardness test on the surface of the scratch resistant film.

FIG. 7 is a flow chart that illustrates a method of manufacturing scratch-resistant film according to embodiments of the present disclosure.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

As used herein, the word “approximately” means “plus or minus 10%.” Additionally, as used herein, the word “transparent” means any material that's allows the transmission of light waves within a transmittance rate of 90% or greater.

Most coating films applied in touch screen devices exhibit a polymer-based molecular structure. Polymers are relatively large molecules which result from chemically linking thousands of relatively small molecules called monomers. Monomers, due to their weak intermolecular forces, can exist in the form of gases, liquids, or structurally weak molecular structures.

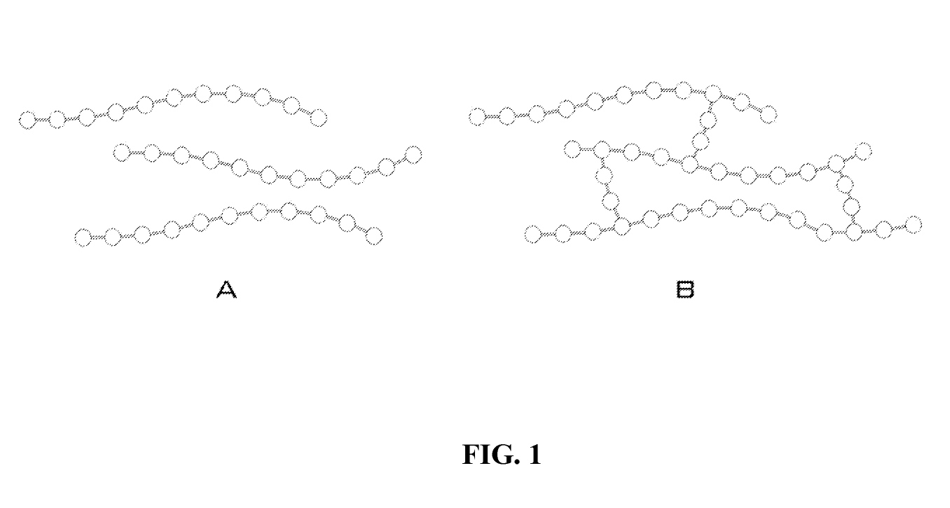

FIG. 1 shows an example of a linear polymer structure A and a cross-linked polymer structure B. As used herein, the term “Cross-Linked” refers to chemical bonds (covalent or ionic) that link polymer chains to each other. In a typical polymerization reaction, monomers with dual functional groups are joined together to form polymers in a linear polymer-like structure A. However, films made with a polymer-based coating film containing linear polymer structure A are not usually scratch resistant. Therefore, in order to increase the scratch resistance of the coating film, the mechanical strength of the polymeric coating needs to be enhanced. Scratch resistance may be defined herein using pencil hardness. As used herein, the term “scratch resistant” is understood to mean a surface with a pencil hardness of about 6H or greater.

Cross-linked polymer structures B are linked together in a three dimensional structure that increases the intermolecular forces (usually covalent bonds) within the polymer chains and reduces the polymeric chain relaxation that usually manifests as a dent or gouge under pressure. Therefore, polymer-based coating films which contain cross-linked polymer structures B, will tend to have better scratch resistant properties than the same polymeric structure without crosslinking.

Although the mechanical strength is higher for a cross-linked polymer structure, application or coating of the polymer onto a substrate may not be possible through a solution process. This is due to the fact that cross-linked polymers cannot dissolve in a solvent and typically swell when placed therein. Coating compositions in a liquid state allow molecules to move and react more efficiently. Organic materials with low molecular weights behave as viscous, liquid-like gels, while materials with high density cross-linked networks are very rigid in their solid state. In accordance with the preferred embodiments, a cross-linked structure is created after it is applied to a substrate in a liquid form. The cross-linked structure may be formed after the material is applied to the substrate.

Embodiments of the invention employ a scratch resistant coating based on a cross-linked structure on multiple layers. This coating may be comprised of multiple layers and may be transparent, translucent, opaque, or combinations thereof as appropriate for the application. Instead of originating from a polymer chain, the coating may be comprised of monomers and oligomers that react simultaneously at different joint points to create a cross-linked, three dimensional polymer structure that exhibits very high cross-linked densities, and hence, scratch resistant features. Specifically, the transparent, scratch resistant coating may comprise mono and multifunctional acrylic monomers and oligomers. This coating may be applied over a rigid substrate or a film formed on that substrate, or over a transparent and flexible substrate, an opaque or translucent substrate, or a film formed over any of those substrates. The coating may be applied over printed patterns, conductive patterns, or other formations disposed on the substrate. The film may be used as a protective cover for displays in electronic devices such as cellular phones and tablet computers, and the coating may be applied in multiple layers. In some embodiments, there may be two layers of coating and in other embodiments there may be more than two layers. The coating layers may be of the same or differing compositions, or combinations thereof. In some embodiments, each layer of coating is cured after being disposed on to the substrate prior to a disposing another layer. The first layer of coating, as well as subsequent layers, may be cured by UV, thermal process, lamellar air flow, or combinations thereof. The hardness of each layer of coating increases gradually. For example, if the outermost layer of coating has a pencil hardness of 6H, the pencil hardness of the layer of coating underneath the outermost layer may be less than that of the outermost layer and more than the pencil hardness of the substrate. The hardness of the whole stack may be at least 6H when measured using a pencil hardness test.

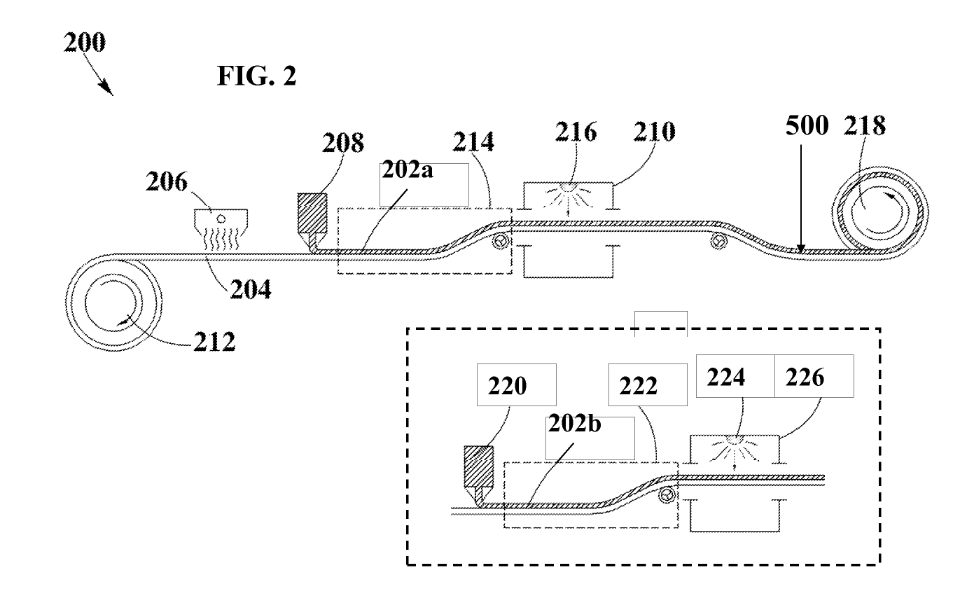

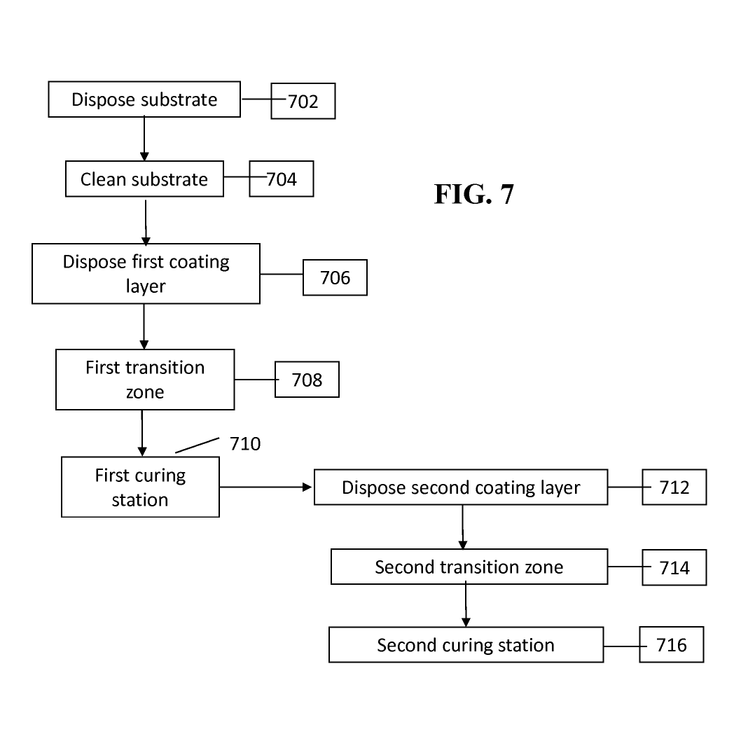

FIG. 2 shows a coating application system that may be used according to embodiments of the present disclosure. FIG. 7 illustrates a flow chart according to embodiments of the present disclosure, FIGS. 2 and 7 are discussed together below. The coating application system 200 may be employed for producing a scratch resistant film 500 in accordance with the various embodiments of the present disclosure. As used herein, the scratch resistant film 500 comprises a substrate 204 and a coating 202 that comprises at least one layer 202a of coating. The coating application system 200 may comprise a corona treatment station 206, a first coating station 208, a transition zone 214, and a curing station 210. During operation, a substrate 204 is fed at block 702 into the coating application system 200 from an unwind roll 212. At block 704, the substrate 204 may be cleaned, for example, the substrate 204 may be treated in a corona treatment station 206. The corona treatment station 206 may remove any small particles, oils, and grease from the surface of the substrate 204 as it is desirable, in at least some embodiments, to have a clean surface before the application of the first layer of scratch resistant coating 202a. Additionally, a corona treatment station 206 may also be used to alter (e.g., increase) the surface energy to obtain sufficient wetting and adhesion of the coating 202a to the substrate 204. As substrate 204 passes through corona treatment station 206, high frequency electrons are discharged onto the surface of substrate 204, forming high polarity groups, which can react with coating compositions and form hydrogen bonds which results in improved adhesion. Generally speaking, when higher levels of electrons are discharged onto the surface of substrate 204, more polar groups and adhesion points are formed which ultimately results in higher surface energy. Another approach to clean the substrate is to use a roll with an adhesive layer and/or substance on its outer surface, which may be referred to as a sticky roll. In some embodiments, a combination of a corona treatment and a sticky roll may be used to clean the surface.

At block 706, a first coating station 208 disposes at least one layer of a coating on to the substrate 204. The first coating station 208 is used to apply a first layer of coating 202a on the substrate 204. It is understood that in some embodiments the coating may not be scratch-resistant as-applied and further processing may be utilized to bring out this property. This first layer of coating 202a may be applied uniformly over the entire surface of the substrate, or in select areas. In the embodiment shown, the first coating station 208 utilizes a Slot-Die process in which the first coating station 208 disposes the first layer of coating by pressure or gravity onto flexible and transparent substrate 204, forming a relatively precise, conformal layer with a thickness ranging from about 1 to 50 microns, with the preferred thickness being between 15 and 20 microns. In some embodiments, instead of a Slot Die coating process, the first layer of coating 202a may also be applied through other commonly employed coating techniques such as Gravure Coating, Meyer Rod Coating, and spray coating.

Referring still to FIG. 2, once substrate 204 is coated with the first layer of coating 202a, the combination of the substrate 204 and the first layer of coating 202a moves on to a first transition zone 214 at block 708. The first transition zone 214 allows for the proper wetting of the first layer of coating 202a across the surface of the substrate 204. In some embodiments, the first transition zone 214 may be held at room temperature (between 20° C. and 30° C.), and in other embodiments it may be held at an elevated temperature above 30° C. The time that the substrate is held in the first transition zone 214 may be from about 5 seconds to about 300 seconds for a given segment of material. At room temperature, the first transition zone 214 allows the coating to settle down and even out over a large area substrate. At an elevated temperature, the viscosity of the coating may be reduced and a smooth and flat surface can be achieved with relative ease. In some embodiments, when solvent is present, the elevated temperature can help to evaporate solvents before the curing process.

Upon exiting the first transition zone 214, the substrate 204 and the coating 202a disposed on its surface passes into a first curing station 210 at block 710. While in the first curing station 210, the first layer of coating 202a forms a cross-linked polymer structure (see B in FIG. 1), which may give or enhance the scratch resistant properties of the first layer of coating 202a. As discussed above in FIG. 1, a cross-link is a bond that links polymer chains nearby. The cross-link density may be defined as the number of effective cross-links per unit volume, as the cross-link density increases, the hardness of a product such as a cured coating also increases. The reaction of the multiple functionalized monomers into a cross-linked polymer structure preferably occurs while the first layer of coating 202a is still in a liquid state to allow the monomers to move around and, as a result, achieve a more efficient cross-linking structure. Additionally, in order to achieve a high cross-link density, it may be preferable to cure the first layer of coating 202a in an inert gas environment or in an environment substantially free of oxygen (e.g. less than 1% oxygen). Examples of suitable inert gases that may be used for this process are nitrogen and carbon dioxide. In the embodiment shown, the first curing station 210 utilizes a ultra-violet (UV) light source 216 which cures the first layer of coating 202a as it passes through the first curing station 210. UV light source 216 can be a UVA, UVB, or UVC ultraviolet light source, and preferably is an industrial grade UV light source since it is desired to cure the first layer of coating 202a in a very short period of time.

In an embodiment, the first layer of coating 202a may be cured from about 0.1 seconds to about 2.0 seconds. Additionally, the UV light source 216 may have a wavelength from about 220 to 480 nm, with target intensity in the range from about 0.25 to about 20.00 J/cm² under an ambient atmosphere. Finally, if an inert environment is applied, the UV light intensity requirement can be reduced up to one order of magnitude and to achieve an equivalent degree of crosslinking.

In an embodiment, subsequent to curing the first layer of coating at first curing station 210, a second layer of coating 202b is disposed at a second coating station 220 at block 712 using coating techniques such as Gravure Coating, Meyer Rod Coating, Slot-die, and spray coating. In an embodiment, the second layer of coating 202b has a lower surface energy than the first layer of coating 202a, which encourages the wetting (even settling) of the second layer of coating 202b when disposed on the first layer of coating 202a. In some embodiments, combinations of methods may be used to dispose the first or second layers (202a, 202b) of coating on the substrate 204. In one embodiment, the same method is used to deposit both layers 202a and 202b, and in an alternate embodiment different methods are used. A second transition zone 222 at block 714 may act in a similar manner to the first transition zone 214. A block 716, upon exiting the second transition zone 222, the substrate 204 and the second layer of coating 202b disposed on its surface passes into a second curing station 226 which may employ an ultraviolet light source 224. While in the second curing station 226, the second layer of coating 202b forms a cross-linked polymer structure (see B in FIG. 1), which may provide or enhance the scratch resistant properties of the second layer of coating 202b.

Upon exiting the second curing station 226 or the first curing station 216 if the second layer 202b is not disposed, the scratch resistant film 500 may be deposited on a wind-up roll 218. While in some embodiments the substrate 204 may originate from the roller 212, the substrate 204 in other embodiments may not be a flexible substrate that originates from the roller 212 and may instead comprise rigid or other flexible substrates 204 that are fed into the system 200 using a plurality of known substrate feeding methods.

In some embodiments, the substrate 204 may comprise polyethylene terephthalate (PET), polyethylene naphthalate (PEN), polycarbonate, cellulosic polymer, polymethyl(methyl)acrylates, or glass. Specifically, suitable materials for the substrate 204 may include DuPont/Teijin Melinex 454 and Dupont/Teijin Melinex ST505, the latter being a heat stabilized film specially designed for processes where heat treatment is involved. Additionally, in some embodiments, the thickness of the substrate 204 may range from 12 to 500 microns, with a preferred thickness of 50 to 150 microns. A rigid substrate may be of any suitable thickness as appropriate for the application and/or processing method(s).

Depending on the material used for the substrate 204, the cleaning at block 704 may comprise a corona treatment which may vary by watt/density within a wide range depending upon the substrate type and/or dimensions. For example, when the substrate 204 is composed of PET film, the intensity level in Corona treatment station 206 may range from about 1 W/min/m² to about 50 W/min/m², while the preferred surface energy may range from about 40 to 95 Dynes/cm. In another embodiment, when the substrate 204 is composed of polycarbonate, the intensity level in Corona treatment station 206 may range from about 1 to 50 W/min/m², while preferred surface energy may range from about 40 to 95 Dynes/cm.

The scratch resistant coating 202 may comprise solid content within a concentration by weight of up to 100%, with a photo-initiator or thermo-initiator concentration in the range of about 1% to 6%. Additionally, the coating 202 may contain about 10 wt. % to about 70 wt. % solids, and, in some embodiments, preferably from about 20 wt. % to about 30 wt. % solvent to regulate viscosity. The solid content may depend on the coating method used and the desired thickness and properties of the finished product.

Examples of solvents that may be used in the coating 202 include but are not limited to ketone-type solvents such as acetone, methyl ethyl ketone, and iso-butyl ethyl ketone, as well as alcohol-type solvents such as ethoxy ethanol and methoxy ethanol. The addition of a solvent does not adversely affect the scratch resistant properties of the coating 202 because it evaporates after the layers are disposed when the substrate 204 goes through an oven channel. Such solvents may also eliminate any residuals left after the substrate 204 passes through the first corona treatment station 206.

In other embodiments, the coating 202 may be composed of 100% of solid content. Generally, when 100% solids content are used, the preferred coating thickness of coating 202 remains substantially the same after being deposited on substrate 204 in a first coating station 208 and passing through curing station 216 (described below). It is easier to achieve thicker coating while using 100% solid resins. Alternatively, when a solvent is used, the thickness of coating 202 will reduce as it is moved throughout coating application system 200 due to the fact that the solvent evaporates out. For example, if a scratch resistant coating 202, with a thickness of 20 microns and a solvent concentration of 20% is deposited on the substrate 204, the thickness may be reduced by 20% or down to 16 microns or less after the substrate 204 passes through curing station 216. The solvents can help manipulate the viscosity that can match the coating facility operation required and it is relatively easier to achieve a thinner coating. This coating 202 may be applied in one or more layers, each layer may comprise a different thickness or the same thickness as the previous layer. In some embodiments, a predetermined hardness of a first layer of coating 202a may be achieved prior to disposing the second layer of coating 202b. This is discussed in detail below.

As stated above, the scratch resistant coating 202 is comprised of a plurality of functional group monomers which react to form a cross-linked polymer structure. Examples of potential functional group monomers that can be used may include propoxylated trimethylolpropane tri(meth)acrylate, highly propoxylated glyceryl triacrylate, trimethylolpropane triacrylate, high purity trimethylolpropane triacrylate, low viscosity trimethylolpropane triacrylate, pentaerythritol triacrylate, propoxylated trimethylolpropane triacrylate, trifunctional acrylate ester, pentaerythritol tetraacrylate, di-tri methylolpropane tetraacrylate, dipentaerythritol pentaacrylate, ethoxylated pentaerythritol tetraacrylate, multifunctional aliphatic urethane or oligomer, multifunctional aromatic urethane or oligomer, and pentaacrylate ester.

Additionally, in order to have proper viscosity for coating process and to control the stress of the cross-linked polymer, lower functionalized monomers can also be introduced. Examples of potential lower functionalized monomers which may be used include polyethylene glycol diacrylate, dipropylene glycol diacrylate, propoxylated neopentyl glycol diacrylate, 1,3-butylene glycol dimethacrylate, neopentyl glycol dimethacrylate, 1,6 hexanediol dimethacrylate, 1,4-butanediol dimethacrylate, and diethylene glycol dimethacrylate.

Finally, a photo initiator including co-initiators and sensitizers as needed under certain conditions can be included in the scratch resistant coating 202 when such coating is cured using a UV light source. The photo-initiators may be, for example, acetophenone, anisoin, anthraquinone, anthraquinone-2-sulfonic acid, sodium salt monohydrate, (benzene) tricarbonylchromium, benzil, benzoin, benzoin ethyl ether, benzoin isobutyl ether, benzoin methyl ether, benzophenone, benzophenone/1-hydroxycyclohexyl phenyl ketone, 50/50 blend, 3,3′,4,4′-benzophenonetetracarboxylic dianhydride, 4-benzoylbiphenyl, 2-benzyl-2-(dimethylamino)-4′-morpholinobutyrophenone, 4,4′-bis(diethylamino)benzophenone, 4,4′-bis(dimethylamino)benzophenone, camphorquinone, 2-chlorothioxanthen-9-one, (cumene)cyclopentadienyliron(ii) hexafluorophosphate, dibenzosuberenone, 2,2-diethoxyacetophenone, 4,4′-dihydroxybenzophenone, 2,2-dimethoxy-2-phenylacetophenone, 4-(dimethylamino)benzophenone, 4,4′-dimethylbenzil, 2,5-dimethylbenzophenone, 3,4-dimethylbenzophenone, diphenyl(2,4,6-trimethylbenzoyl)phosphine oxide/2-hydroxy-2-methylpropiophenone, 50/50 blend, 4′-ethoxyacetophenone, 2,4,6-trimethylbenzoyldiphenylphophine oxide, phenyl bis(2,4,6-trimethyl benzoyl)phosphine oxide, 2-ethylanthraquinone, ferrocene, 3′-hydroxyacetophenone, 4′-hydroxyacetophenone, 3-hydroxybenzophenone, 4-hydroxybenzophenone, 1-hydroxycyclohexyl phenyl ketone, 2-hydroxy-2-methylpropiophenone, 2-methylbenzophenone, 3-methylbenzophenone, methybenzoylformate, 2-methyl-4′-(methylthio)-2-morpholinopropiophenone, phenanthrenequinone, 4′-phenoxyacetophenone, thioxanthen-9-one, triarylsulfonium hexafluoroantimonate salts, mixed, 50% in propylene carbonate, and triarylsulfonium hexafluorophosphate salts, mixed, 50% in propylene carbonate.

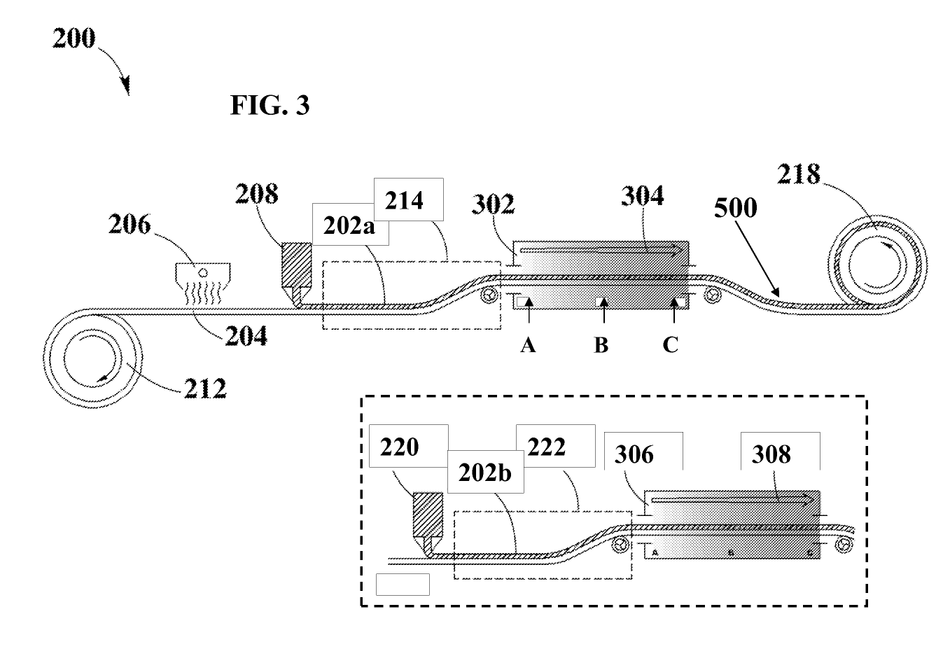

Turning now to FIG. 3, FIG. 3 illustrates a system that may be capable of executing an embodiment of the present disclosure. Here, a scratch resistant film 500 is produced in substantially the same manner as is described in FIG. 2 above. The steps at blocks 702-716 may proceed as indicated in FIG. 7. However, in lieu of a UV light source (216 in FIG. 2) at block 710, a first thermo-curing station 302 utilizes heat radiation along a first temperature gradient 304 to cause the first layer of coating 202a deposited on the substrate 204 by the first coating station 208 to form a cross-linked polymer structure. The first temperature gradient 304 in the curing station 302 is designed such that it progressively cures the first layer of coating 202a within a period of time of about 5 seconds to about 300 seconds. In some embodiments, a relatively slow thermal curing process may reduce the thermal stress and reduce any possible curl-up effect (delamination) on the first layer of coating 202a. In an embodiment, the temperature gradient 304 creates and maintains three temperature zones A, B, and C, which may be, respectively, about 70° C., about 120° C., and about 200° C. In an alternate embodiment, temperature zone A may be from about 50° C. to about 90° C., temperature zone B may be from about 100° C. to about 140° C., and temperature zone C may be from 180° C. to about 220° C. In other embodiments, the temperature zones may range from 40° C. to 300° C. depending upon the manufacturing process, materials, and end application. If a thermo-initiator is included in coating 202, while passing through the first thermo-curing station 302, the activation temperature of such thermo-initiator may range from 70° C. to 200° C. In an embodiment, the preferred temperature of the first thermo-curing module 302 is in the range of 70-150° C., which should match the stability of the substrate.

In the embodiment in FIG. 3, the substrate 204 may undergo a second coating and a second curing process. In this embodiment, at block 712 at second coating station 220, a second coating layer 202b is disposed on top of the first layer 202a. In some examples, the second coating layer 202b is disposed at block 714 subsequent to the curing of the first layer 202a at block 716, and in other examples there may not be an intermediate hardening step prior to the deposition of the second layer of coating 202b. The second coating layer 202b may pass through the transition zone 222 prior to curing in a second curing module 306 that comprises a second temperature gradient 308. The second transition zone 222 and second temperature gradient 308 may be configured as discussed above with respect to FIGS. 2 and 3, respectively. The film 500 may then be wound on the wind roll 218, or, if a rigid substrate or flexible non-roll substrate it used, it may be otherwise removed from the system 200.

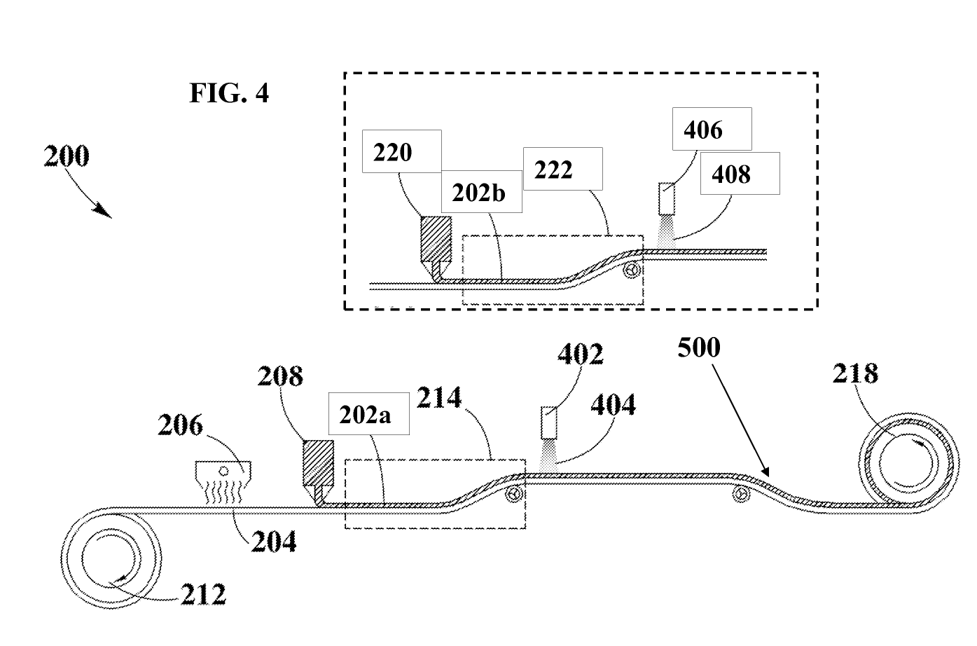

Referring now to FIG. 4, FIG. 4 illustrates a system that may be capable of executing an embodiment of the present disclosure. Here, a scratch resistant film 500 is produced in substantially the same manner from blocks 702-716 as is described in FIG. 7 above. However, in lieu of a UV light source (216 in FIG. 2) at block 710 and/or block 716, the current embodiment utilizes ionizing radiation to cure and form a cross-linked polymer structure within coating 202. Specifically, the embodiment shown employs a first Electronic-beam (E-Beam) station 402. In this embodiment, the first E-beam curing station 402 applies a first electron discharge 404 to cure the first coating layer 202a. More specifically, the first E-beam station 402 utilizes highly energetic electrons at controlled doses to quickly polymerize and cross-link polymeric materials. In an embodiment, there may be a second coating layer 202b applied at a second coating station 222. The second coating layer may then enter the a second transition zone 222 and then a second e-beam curing station 406 that uses a second electron discharge 408 and may be configured similarly to the first E-beam curing station 402. While the embodiments disclosed in FIGS. 2-4 discuss using the same method to cure the first coating layer 202a and the second coating layer 202b, in some embodiments (not pictured) one type of curing module may be used to cure the first layer 202a and a different type of curing module may be used to cure the second layer 202b.

Due to the use of the first E-beam module 402 and/or the second E-beam module 406, there may not be a thermo or photo-initiator added to the coating 202 (in either layer 202a or 202b) because the electrons within the solution act as the initiator. In an embodiment, E-beam doses applied to the scratch resistant coating 202 may range from about 0.5 to 5 MRads for about 0.01 to 5 seconds.

Cross-link density refers to the percentage of cross-linked bonds within a given polymer. Such density is related to reaction time and temperature. Generally, a higher intensity and faster reaction translates into a higher cross-linked density. As such, different curing methods provide different densities in terms of the percentage of cross-linked reaction. Maximum cross-linked densities (measured after curing) may range from about 50% to 60% using a thermo curing process, 60% to 70% using UV curing, and up to 80% using E-beam curing. In some embodiments, from a manufacturing perspective in terms of processing speed, cost and power requirements, UV curing may be the preferred curing method. Alternatively, if a superior optical finish is desired, thermo-curing may be preferred.

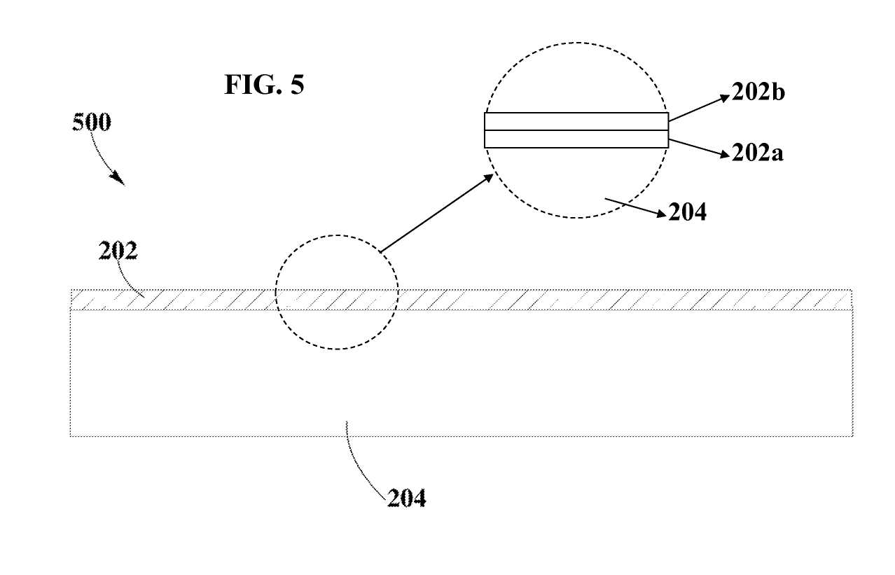

Referring to FIG. 5, a cross-section of a scratch resistant film 500 is shown. The scratch resistant film 500 generally includes a substrate 204, and a scratch resistant coating 202. Furthermore, coating 202 may add about 10 to 20% of weight compared to the total weight of the scratch resistant film 500 depending on the size the of the electronic display that requires protective cover. In a preferred embodiment, first and second coating layers 202a and 202b cannot physically separate and/or are not optically distinguishable, that is, the layers will not delaminate. In some embodiments, as discussed in FIGS. 2-4 and illustrated in FIG. 5, the coating 202 may comprise a plurality of layers including first layer 202a and second layer 202b.

In some embodiments, the coating 202 may be disposed over the substrate 204 as well as something else disposed on the substrate, for example, ink, paper, or other materials that were disposed on the substrate 204 prior to the application of the coating 202. The materials may be disposed on the substrate 204 prior to the application of the first coating layer 202a or in between the first coating layer 202a and the second coating layer 202b (or other subsequent layers), or may be disposed on the substrate and/or between the layers of coating in various combinations thereof.

In some embodiments, the scratch resistant film 500 may further include a transparent and flexible adhesive layer (not shown), which is adhered to substrate 204 on the opposite side of the substrate 204 on which the coating 202 is disposed. The adhesive layer allows attachment of the scratch resistant film 500 to electronic touch displays and other surfaces which may include those found on devices such as, mobile phones and tablet computers. The thickness of the adhesive layer may range from about 20 microns to about 50 microns. For example, adhesive layer may be constructed from 3M Optically Clear Adhesive #8171. In some embodiments, as discussed above and shown in FIG. 5, the coating 202 may comprise a plurality of coating layers, for example, the first layer 202a and the second layer 202b.

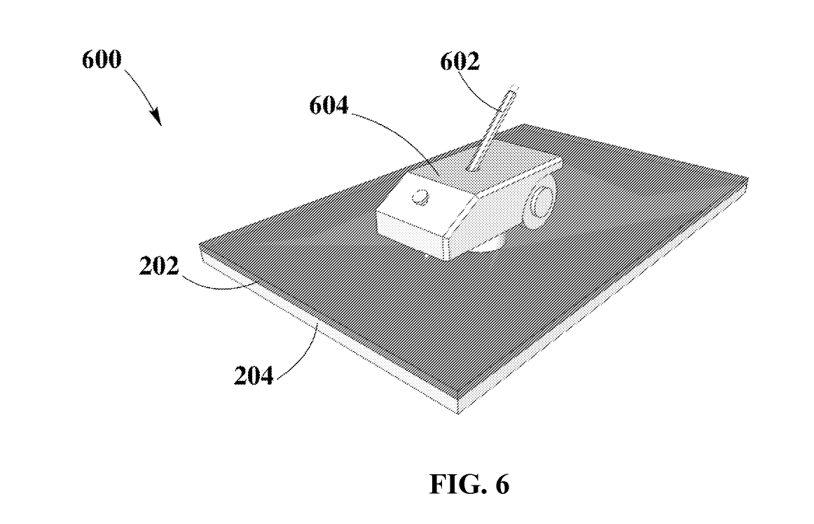

Referring now to FIG. 6, a pencil hardness test 600, which complies with test method ASTM D3363, for measuring the surface hardness of coating 202 as well as the intermediate layer 202a is shown. To perform the test, a pencil 602 is selected from set of pencils that exhibit hardness ranging from 1H to 9H. Selecting from highest hardness to lowest hardness, a first pencil 602 is loaded into the measuring cart 604. The measuring cart 604 used in this test is the Elcometer 3080 which is commercially available from BAMR. This measuring instrument enables pencil 602 to be maintained at a constant pressure force of about 7.5 N, and at the appropriate angle, which increases the reproducibility of the test. With pencil 602 loaded, measuring cart 604 is moved across the surface of coating 202. If the pencil 602 leaves a scratch, the next softer pencil 602 is used and the process is repeated. The hardness number of the first pencil 602 that does not leave a mark is considered the pencil hardness of coating 202.

Using thicknesses from about 5 to 50 microns, pencil hardness of coating 202 on top of the substrate 204 that is made of PET is measured from 2H up to 9H, depending on the thickness of the scratch resistant coating 202. Employing a preferred thickness of 15 microns on the scratch resistant coating 202 over PET substrate 204, surface pencil hardness greater than or equal to 6H can be achieved. Performance characteristics of coating 202 that is applied to a PET substrate 204 are shown in Table 1.

TABLE 1

| CATEGORY | SPECIFICATION | CHARACTERISTICS |
|---|---|---|
| Optical | Transmittance | >93% |
| Performance | | |
| | Haze | <1% |
| | Gloss | 20° = 95, 60° = 97, 85° = 99 |
| | Brightness Loss | <1.7% optical loss |
| | | when on display |
| | Index of Refraction | 1.48-1.54 |
| Scratch | Hardness | 2H-9H |
| Resistance | | |
| Thermal Stress | Operating Temperature | −20° C. to 65° C., 90 Cycles |
| | Storage Temperature | −40° C. for 72 hrs, |
| | | 85° C. for 10 hrs |
| Chemical | Chemical Resistance | Exposure* for 1 hour @ 70° F. |

*IPA, acetone, glass cleaner, vinegar, coffee, tea, cola, ketchup, mustard

Additionally, performance characteristics of scratch resistant coating 202 applied to a polycarbonate substrate are shown in Table 2.

TABLE 2

| CATEGORY | SPECIFICATION | CHARACTERISTICS |
|---|---|---|
| Optical | Transmittance | >93% |
| Performance | | |
| | Haze | <1% |
| | Gloss | 20° = 95, 60° = 97, 85° = 99 |
| | Brightness Loss | <1.7% optical loss |
| | | when on display |
| | Index of Refraction | 1.48-1.54 |
| Scratch | Hardness | 2H-5H |
| Resistance | | |
| Thermal Stress | Operating Temperature | −20° C. to 65° C., 90 Cycles |
| | Storage Temperature | −40° C. for 72 hrs, |
| | | 85° C. for 10 hrs |
| Chemical | Chemical Resistance | Exposure* for 1 hour @ 70° F. |

*IPA, acetone, glass cleaner, vinegar, coffee, tea, cola, ketchup, mustard

In comparing Table 1 and Table 2, it can be seen that the scratch resistance varies as a result of the different substrate materials, whereas other properties may not be impacted or significantly impacted. The reason is that polycarbonate substrate is softer than PET substrate. Therefore, the maximum surface hardness that coating 202 is able to achieve may be lower when applied over a polycarbonate substrate as opposed to a PET substrate.

While the preferred embodiments of the invention have been shown and described, modifications thereof can be made by one skilled in the art without departing from the spirit and teachings of the invention. The embodiments described and the examples provided herein are exemplary only, and are not intended to be limiting. Many variations and modifications of the invention disclosed herein are possible and are within the scope of the invention. Accordingly, the scope of protection is not limited by the description set out above, but is only limited by the claims which follow, that scope including all equivalents of the subject matter of the claims.

What is claimed is:

1. A scratch resistant film, comprising:
a substrate; and
a coating disposed on the substrate, wherein the coating comprises a cross-linked polymer structure formed from a plurality of functionalized monomers, wherein the coating comprises a plurality of layers, wherein the scratch resistant film has a pencil hardness of at least 6H.

2. The film of claim 1, wherein the coating has a cross-link density of at least 50%.

3. The film of claim 1, wherein the coating comprises a plurality of acrylic monomers, wherein each acrylic monomer of the plurality of acrylic monomers comprises between 1 and 6 acrylic functional groups.

4. The film of claim 1, wherein the substrate comprises at least one of polyethylene terephthalate, polyethylene naphthalate, polycarbonate, semiconductors, organic materials, cellulosic polymer, polymethyl(methyl)acrylates, printed circuit boards, and glass, as well as combinations thereof.

5. The film of claim 1, wherein the scratch-resistant film has a pencil hardness of up to 9H.

6. A method of manufacturing a scratch resistant film, comprising:
altering a surface energy of at least a portion of a substrate;
disposing a first layer of coating on the substrate, wherein the first layer of coating comprises a plurality of functionalized monomers and a solvent;
curing the first layer of coating;
disposing a second layer of coating on the first layer of coating, wherein the second layer of coating has a lower surface energy than a surface energy of the first layer of coating;
curing the second layer of coating; and
forming, in response to curing the second layer of coating, a scratch-resistant film.

7. The method of claim 6, further comprising cleaning the surface of the substrate, wherein cleaning the surface of the substrate and altering the surface energy of at least a portion of the substrate comprises applying a stream of high frequency electrons to the surface of the substrate.

8. The method of claim 7, wherein an intensity level of the stream of high frequency electrons is between about 1 W/min/m² and about 50 W/min/m².

9. The method of claim 6, wherein the altered surface energy of the at least a portion of the substrate is between 20 Dynes/cm and 95 Dynes/cm subsequent to alteration.

10. The method of claim 6, wherein each of the first layer of coating and the second layer of coating has a thickness between 3 microns and 50 microns.

11. The method of claim 6, wherein curing the first layer of coating uses a different curing technique than curing the second layer of coating.

12. The method of claim 11, wherein, subsequent to disposing the first layer of coating, disposing the substrate in a transition zone, wherein the transition zone comprises a plurality of temperature zones that range from about 70° C. to about 200°.

13. The method of claim 12, wherein a first temperature zone of the plurality of temperature zones is about 70° C., wherein a second temperature zone of the plurality of temperature zones is about 120° C., and wherein a third temperature zone of the plurality of temperature zones is about 200° C.

14. The method of claim 6, wherein curing the scratch resistant coating comprises applying ionizing radiation to the scratch resistant coating using an electronic beam.

15. The method of claim 14, wherein applying the electron beam further comprises applying doses of electrons ranging from about 0.5 MRads to about 5 MRads over a time period ranging from about 0.01 seconds to about 5 seconds.

16. The method of claim 6, wherein the scratch resistant coating further comprises at least one of a photo-initiator or a thermo-initiator.

17. The scratch resistant film of claim 6, wherein the scratch resistant film has a cross link density of at least 50%.

18. A scratch resistant film, comprising:
a substrate;
a scratch resistant coating disposed on the substrate;
wherein the scratch resistant coating comprises a cross-linked polymer structure comprising a plurality of layers and formed from a plurality of functionalized monomers;
wherein a pencil hardness of the scratch-resistant coating is at least 6H.

19. The scratch resistant film of claim 18, wherein the scratch resistant coating has a cross-link density of at least 50%.
